(19) United States
(12) Patent Application Publication
(10) Pub. No.: US 2012/0135278 A1
(43) Pub. Date: May 31, 2012

(54) REDOX FLOW BATTERY

(76) Inventors: Tomohisa Yoshie, Osaka-shi (JP); Naoto Nishimura, Osaka-shi (JP); Yoshihiro Tsukuda, Osaka-shi (JP); Hisayuki Utsumi, Osaka-shi (JP); Yuki Watanabe, Osaka-shi (JP); Akihito Yoshida, Osaka-shi (JP); Shunsuke Sata, Osaka-shi (JP); Shinobu Takenaka, Osaka-shi (JP); Masaki Kaga, Osaka-shi (JP)

(21) Appl. No.: 13/377,223

(22) PCT Filed: Jun. 8, 2010
(86) PCT No.: PCT/JP2010/059707

§ 371 Date: Feb. 8, 2012

(30) Foreign Application Priority Data
Jun. 9, 2009 (JP) 2009-138414

(51) Int. Cl. H01M 4/38; H01M 4/48; H01M 2/00

(52) U.S. Cl. 429/7; 429/105

(57) ABSTRACT

A redox flow battery comprising an electrode cell including a negative electrode cell, a positive electrode cell and a separator for separating them, in which at least one of the negative electrode cell and the positive electrode cell includes a slurry type electrode solution, a porous current collector and a casing; a tank for storing the slurry type electrode solution; and a pipe for circulating the slurry type electrode solution between the tank and the electrode cell.

### TECHNICAL FIELD

The present invention relates to a redox flow battery. Further in detail, the present invention relates to a redox flow battery using a slurry type negative electrode solution and/or positive electrode solution.

### BACKGROUND ART

Renewable clean energy such as photovoltaic power generation, wind power generation, hydroelectric power generation, etc. is highly expected to be main energy sources in place of fossil energy sources. However, these energy sources are disadvantageous at a point that the electric power to be obtained is considerably fluctuated depending on the environmental changes since utilizing natural energy. Therefore, at the time of supplying the electric power obtained by these energy sources to a presently existing electric power system including a thermal electric power generation or nuclear electric power generation, it is needed to once store electric power for stabilization and then supply the electric power.

For such electric power storage, use of a rechargeable battery such as a redox flow battery and a NAS (sodium sulfur) battery, a superconducting flywheel, or the like has been investigated. Particularly, a redox flow battery appears promising as a rechargeable battery for electric power storage since it can be operated at normal temperature and the capacity of power storage can easily be designed by increasing or decreasing the volume of the electrode solution to be used.

Presently, a vanadium redox flow battery, one of redox batteries, is now in a practical application stage (e.g., Bulletin of the Electrotechnical Laboratory, vol. 63, no. 4, 5: Non-Patent Document 1). Further, Japanese Patent Application Laid-Open (JP-A) No. 2005-209525 (Patent Application 1) proposes a uranium redox flow battery using a non-protonic organic solvent, U⁴⁺/U³⁺ for the negative electrode reaction, and UO₂⁺/UO₂²⁺ for the positive electrode reaction since higher electromotive force than a vanadium redox flow battery can be given.

### PRIOR ART DOCUMENTS

### Patent Documents

Patent Document 1: JP-A No. 2005-209525

### Non-Patent Document

Non-Patent Document 1: Bulletin of the Electrotechnical Laboratory, vol. 63, no. 4, 5

### SUMMARY OF THE INVENTION

### Problems to be Solved by the Invention

In a vanadium redox flow battery and a uranium redox flow battery, the solubility of substances which cause a redox reaction in an electrode solution to be used is low. Therefore, the energy density of the battery to be obtained is no more than ten-odd to several tens Wh/L. Consequently, to construct an electric power storage system with such a low energy density, the installation scale becomes considerably huge. For that, it is desired to heighten the energy density and increase the electric power storage amount per installation scale as much as possible.

### Means for Solving the Problems

Accordingly, the present invention provides a redox flow battery comprising an electrode cell including a negative electrode cell, a positive electrode cell and a separator for separating them, in which at least one of the negative electrode cell and the positive electrode cell includes a slurry type electrode solution, a porous current collector and a casing; a tank for storing the slurry type electrode solution; and a pipe for circulating the slurry type electrode solution between the tank and the electrode cell.

### Effects of the Invention

In a redox flow battery of the present invention, the negative electrode solution and/or the positive electrode solution are/is slurry type electrode solution and a current collector in the negative electrode cell and/or the positive electrode cell in the side containing the electrode solution are/is a porous current collector.

Use of the slurry type electrode solution makes it possible to realize an electric power storage system with high charge/discharge efficiency while keeping a high energy density.

Further, use of the porous current collector makes it possible to increase the collision of solid particles against the current collector even if the solid particles are used as an active material which causes a redox reaction in the slurry type electrode solution. As a result, the charge/discharge efficiency can be increased.

Further, clogging with the solid particles can be prevented by specifying the configuration and arrangement position of the porous current collector.

Further, attributed to that the fine pores in the porous current collector are meandered in a specified direction, the contact time with the positive electrode solution and/or the negative electrode solution can be prolonged and a higher energy density and charge efficiency can be attained.

Still further, by further including a control circuit for controlling the flow speed of the slurry type electrode solution, components in the slurry type electrode solution are prevented from remaining in the current collector and therefore, a higher energy density and charge efficiency can be attained.

Moreover, attributed to that the slurry type electrode solution is the negative electrode solution in the negative electrode cell side and contains solid type negative electrode active material particles of metal particles and a non-aqueous solvent, a higher energy density and charge efficiency can be attained.

Furthermore, attributed to that the slurry type electrode solution is the negative electrode solution in the negative electrode cell side and contains solid type negative electrode active material particles of lithium particles, a higher energy density and charge efficiency can be attained.

Furthermore, attributed to that the slurry type electrode solution contains a non-aqueous type solvent of an ionic liquid, it is made possible to obtain a maintenance-free redox flow battery.

### BRIEF DESCRIPTION OF THE DRAWINGS

FIG. 1 is a schematic configuration drawing of a redox flow battery of the present invention.

FIG. 2 is a schematic explanatory drawing of the slurry type negative electrode solution.

FIG. 3a is a schematic cross sectional view of one example of a negative electrode current collector of the present invention.

FIG. 3b is a schematic cross sectional view in the A-A′ plane of FIG. 3a.

FIG. 4 is a schematic cross sectional view of one example of a negative electrode current collector of the present invention.

FIG. 5 is an explanatory drawing of the meandering of the slurry type negative electrode solution.

FIG. 6 is a schematic configuration drawing of a redox flow battery of the present invention.

### PREFERRED MODES OF EMBODIMENTS OF THE INVENTION

### Configuration of Redox Flow Battery

A redox flow battery of the present invention has an electrode cell including a negative electrode cell, a positive electrode cell and a separator for separating them. Additionally, in the above description, a positive electrode and a negative electrode are collectively called as an electrode.

At least one of the negative electrode cell and the positive electrode cell includes a slurry type electrode solution, a casing and a current collector. Additionally, the current collector of the electrode cell in the side containing the slurry type electrode solution is a porous current collector. If the current collector is porous, the number of times of collision of solid particles in the slurry type electrode solution with the current collector can be increased. As a result, an electric power storage system with high charge/discharge efficiency while keeping a high energy density can be attained. Herein, the porous current collector is not necessarily needed to be adjacent to the casing and the separator; however, it is preferable that the porous current collector is adjacent to at least one of the casing and the separator and it is more preferable that the porous current collector is adjacent to both of the casing and the separator. If the porous current collector is adjacent to at least one of the casing and the separator, it is made possible to pass the electrode solution more to the current collector and it is made easier to fix the current collector in the battery. Further, if the current collector is adjacent to both of the casing and the separator, it is made possible to pass the electrode solution further more to the current collector and it is made further easier to fix the current collector in the battery.

Still further, the redox flow battery has a tank for storing the slurry type electrode solution and a pipe for circulating the slurry type electrode solution between the tank and the electrode cell.

Owing to the above-mentioned configuration, an electric power storage system with high charge/discharge efficiency while keeping a high energy density can be realized.

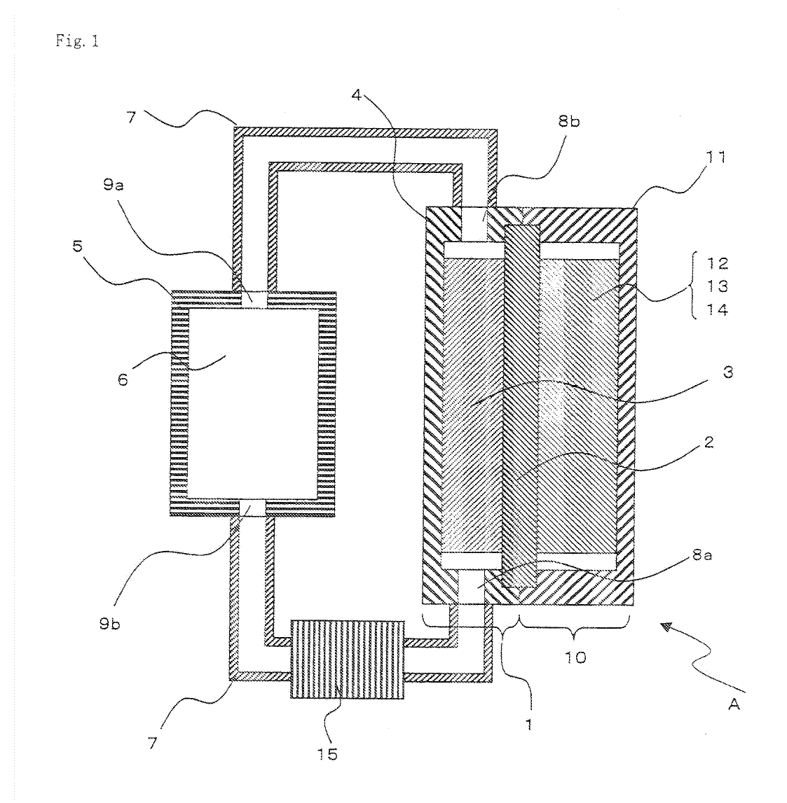

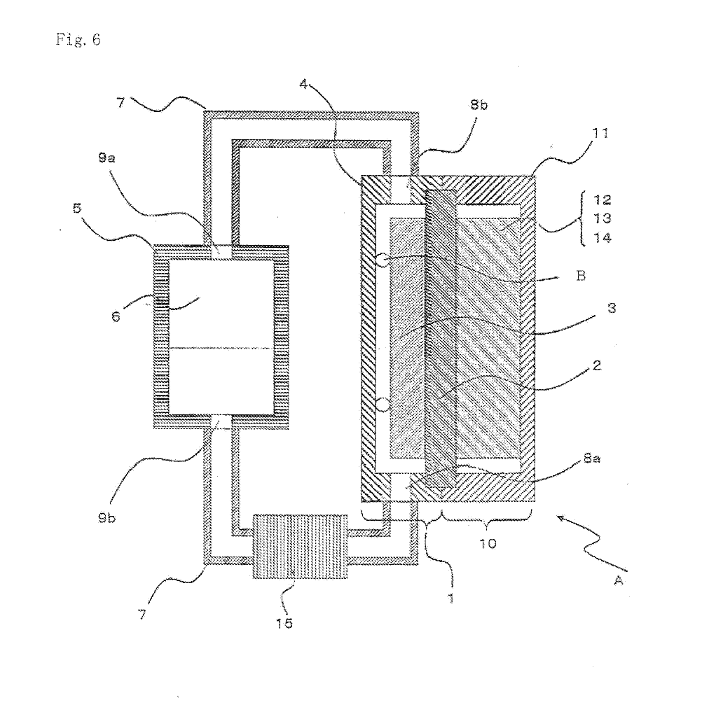

Hereinafter, one embodiment of a redox flow battery will be described with reference to FIGS. 1 and 6.

FIGS. 1 and 6 are schematic configuration drawings of a redox flow battery of the present invention. The redox flow battery A shown in FIG. 1 has a negative electrode cell 1 and a positive electrode cell 10. The negative electrode cell 1 and the positive electrode cell 10 are separated by a separator 2. At least one of the negative electrode cell 1 and the positive electrode cell 10 includes a slurry type electrode solution, a casing and a current collector. FIG. 1 shows an example of a case that only the negative electrode cell 1 has the slurry type electrode solution (negative electrode solution); however a slurry type electrode solution (positive electrode solution) may be used also for the positive electrode cell, or a positive electrode solution may be used only for the positive electrode cell.

In FIG. 1, the current collector 3 in the negative electrode cell 1 in the side containing the negative electrode solution is porous and installed adjacently to a casing 4 and a separator 2. In FIG. 6, the current collector 3 is installed adjacently to the separator 2, but not adjacently to the casing 4 (having no direct contact) since a buffer material B is installed between the current collector 3 and the casing 4. Further, the redox flow battery has a tank 5 storing a negative electrode solution 6 and a pipe 7 for circulating the negative electrode solution 6 between the tank 5 and the negative electrode cell 1 in the side containing the negative electrode solution.

The buffer material B is not particularly limited if it contains a material which is not reacted with or dissolved in the substances of the electrode solution (negative electrode solution in FIG. 6) and is a material having a buffering property. The buffer material B may include resin particles or round rods. Additionally, in FIG. 6, the buffer material is used as a spacer for preventing the current collector and the casing from neighboring to each other and a spacer having no buffer property may be used. The volume formed by the buffer material B between the current collector 3 and the casing 4 is preferably 20% or lower in the entire volume of the negative electrode cell.

In FIGS. 1 and 6, the numeral reference 8a indicates a flow-in port of the negative electrode solution 6 to the negative electrode cell; 8b indicates a flow-out port of the negative electrode solution 6 from the negative electrode cell; 9a indicates a flow-in port of the negative electrode solution 6 to the tank; 9b indicates a flow-out port of the negative electrode solution 6 from the tank; and 15 indicates a pump.

The positive electrode cell 10 has a positive electrode active material 12, a non-aqueous solvent 13 and a current collector 14 in a casing 11.

As shown in FIGS. 1 and 6, since the porous current collector 3 is installed adjacently to both of the casing 4 and the separator 2 or only to the casing 4, the negative electrode solution 6 can be passed through the porous current collector. As a result, since the flow speed of the negative electrode solution 6 in the fine pores of the porous current collector can be increased, clogging of the porous current collector due to deposition (choking) of the solid matter of the negative electrode solution 6 can be suppressed. That is, increased of the inner impedance due to the rate-limiting substance diffusion can be prevented and consequently, charge/discharge can be carried out at a high current density.

Hereinafter, an operation principle of the redox flow battery of the present invention and representative embodiments of respective constituent members will be described.

### (Operation Principle of Redox Flow Battery)

The redox flow battery shown in FIG. 1 uses a slurry as the negative electrode solution. The negative electrode solution generally contains solid negative electrode active material particles and a non-aqueous solvent. Further, the negative electrode solution shows a liquid type property and is stored in the tank 5 and supplied to the negative electrode cell 1 by the pump 15.

At the time of a discharge reaction, in the case where, for example, solid negative electrode active material particles are lithium particles in the negative electrode cell 1, collision of the lithium particles against the current collector 3 causes an oxidation reaction: negative electrode cell: Li (solid)→Li⁺ (ion)+e⁻(electron).

At that time, the generated electrons are collected in the current collector 3 and flow to the current collector 14 via an outside load from an outside wiring (lighting, electronic appliances, motors, heaters, and the like.). On the other hand, Li⁺ is transferred to the positive electrode cell 10 from the negative electrode cell 1 via the non-aqueous solvent through the separator 2.

On the other hand, in the positive electrode cell 10, in the case where the positive electrode active material 12 is, for example, lithium cobaltate (LiCoO₂), Li⁺ (ion) is transferred to the non-aqueous solvent 13 from the separator 2 in the positive electrode cell 10. Additionally, electrons flowing to the current collector 14 together with the transferred Li⁺ cause a reduction reaction of, positive electrode cell: Li₁₋ₓCoO₂+xLi⁺(ion)+xe⁻(electron)→LiCoO₂.

On the other hand, at the time of the charge reaction, contrarily to the discharge reaction, the redox reaction is caused; negative electrode cell: Li⁺ (ion)+e⁻(electron)→Li (solid), and positive electrode cell: LiCoO₂→Li₁₋ₓCoO₂+xLi⁺(ion)+xe⁻, by an outside electric power source.

At that time, the electrons generated in the positive electrode cell 10 are collected in the current collector 14 and flow to the current collector 3 of the negative electrode side via the outside electric power source (a charger, a direct current power source, or the like) via an outside wiring. Meanwhile, Li⁺ (ion) is transferred to the negative electrode cell 1 from the positive electrode cell 10 via the non-aqueous solvent 13 through the separator 2.

In the above-mentioned manner, charge/discharge can be carried out.

### (Slurry Type Electrode Solution)

The slurry type electrode solution means a dispersion liquid containing solid type electrode active material particles dispersed in a non-aqueous solvent. The solid type electrode active material particles are of solid type negative electrode active material in the negative electrode and of solid type positive electrode active material in the positive electrode. The concentration of the solid type active material in the electrode solution is not particularly limited. However, if the concentration is too high, the porous current collector tends to be clogged easily, and if the concentration is too low, the storage performance may be deteriorated in some cases. Therefore, the concentration of the solid type active material is preferably in a range of 0.5 to 20 wt. % and more preferably in a range of 2 to 50 wt. %.

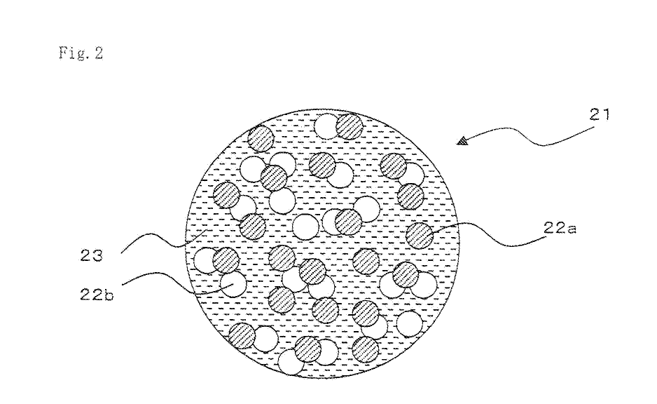

FIG. 2 shows a schematic explanatory drawing of the slurry type negative electrode solution 21. The negative electrode solution 21 contains solid negative electrode active material particles 22a and 22b causing a redox reaction at the time of charge/discharge reactions and a non-aqueous solvent 23 capable of dispersing these particles and showing a liquid property. To the slurry type negative electrode solution 21, a supporting electrolyte (not illustrated) may be added in order to improve the ion conductivity of the solution. Also in the positive electrode cell side, a slurry type positive electrode solution may be used. In this case, similarly to the negative electrode solution 21, the solid type positive electrode active material particles and a non-aqueous solvent capable of dispersing the particles can be used. Additionally, it is shown that the particles 22a are positioned before the particles 22b. Hereinafter, the respective components of the electrode solutions (negative electrode solution and positive electrode solution) will be described.

(A) Negative electrode solution

(1) Solid Negative Electrode Active Material Particles

Examples usable as solid negative electrode active material particles are particles of organic compound materials such as quinone type ones (e.g. benzoquinone, naphthoquinone and anthraquinone) and thiol type ones (e.g. benzene thiol, butane-2,3-dithiol and hex-5-ene-3-thiol); carbon materials such as graphite, hard carbon, black lead and active carbon; metal materials such as lithium, sodium, potassium, magnesium, calcium, zinc, aluminum and strontium; lithium alloy materials such as lithium-tin type and lithium-silicon type; and transition metals such as vanadium, uranium, iron and chromium.

Among the particles of the above-mentioned materials, carbon material particles are preferable in the case where lithium ion involves the redox reaction. Among the carbon material particles, graphite particles bearing amorphous carbon on the surface are particularly preferable to be used. Use of graphite particles significantly suppresses a decomposition reaction of an organic solvent and a lithium salt generated in the negative electrode reaction at the time of charge. As a result, a battery with an improved the charge/discharge cycle life and in which gas generation due to the decomposition reaction is suppressed can be obtained.

Further, metal material particles which can be converted from solid to ion at the time of discharge and from ion to solid at the time of charge are preferable to be used. The metal material particles are excellent in high discharge capacity per unit volume and weight. The metal material particles gradually become small in their particle size due to partial ionization every time the particles collide against the current collector at the time of discharge. Therefore, clogging of the current collector with the metal material particles can be suppressed. Further, it has been known that a metal material generally generates a needle-like precipitate (dendrite precipitate) on the current collector surface at the time of charge. The dendrite precipitate can be broken and removed in the case where it is grown to a prescribed size by adjusting the sending pressure of the negative electrode solution. Therefore, extreme particle size increase of the metal material particles hardly occurs and the particle diameter size can be kept constant.

The particle diameter of the solid negative electrode active material particles is preferably 0.01 to 100 μm. If the particle diameter is small, the particles can be dispersed evenly in a non-aqueous solvent. Therefore, a slurry having a sufficient liquid property can be obtained. As a result, the negative electrode solution can be sent (circulated) by an economical pump with no need of using a special pump.

Particularly, as a non-aqueous solvent, an ionic liquid with high viscosity described below is preferable since separation of the solid negative electrode active particles and the non-aqueous solvent is hardly caused and the liquid property can be maintained stably.

Further, the particle diameter of the solid negative electrode active material particles at the time of loading is preferably 0.01 μm or larger. The particles with a particle diameter of 0.01 μm or larger are advantageous at a point that the particles hardly form agglomerates in the negative electrode solution and that the negative electrode current collector is hardly clogged with them. Further, the particles are advantageous also at a point that the production cost is low and the particles are made economically available. Additionally, particles smaller than 0.01 μm can be used, the solid negative electrode active material particles are grown by electro-deposition at the time of charge. Therefore, even if particles with particle diameter of 0.01 μm or less are used, the particles are grown every time charge/discharge is repeated and therefore, use of particles with particle diameter smaller than 0.01 μm is meaningless.

(2) Non-Aqueous Solvent

Examples of the nonaqueous solvent to be used for the negative electrode cell may be cyclic carbonates such as propylene carbonate (PC), ethylene carbonate (EC) and butylene carbonate; chain carbonates such as dimethyl carbonate (DMC), diethyl carbonate (DEC), ethyl methyl carbonate and dipropyl carbonate; lactones such as γ-butyrolactone (GBL) and γ-valerolactone; furans such as tetrahydrofuran and 2-methyltetrahydrofuran; ethers such as diethyl ether, 1,2-dimethoxyethane, 1,2-diethoxyethane, ethoxymethoxyethane, dioxane, triethylene glycol dimethyl ether and tetraethylene glycol dimethyl ether; dimethyl sulfoxide, sulfolane, methyl sulfolane, acetonitrile, methyl formate, methyl acetate, etc. Ionic liquids are also usable.

Particularly, an ionic liquid having neither volatility nor combustibility is preferable in terms of the safety, and the combustibility can be removed by addition to a volatile non-aqueous solvent. In addition, a volatile non-aqueous solvent has to be supplemented periodically since it is evaporated, and on the other hand, since an ionic liquid is not volatile, the number of times for supplementation can be decreased and thus the ionic liquid is advantageous at a point that the maintenance cost can be reduced.

Examples of an ionic liquid may be molten salts of imidazolium type cation with boron fluoride anion (BF₄_{^{−}}, hexafluorophosphoric acid anion (PF₆_{^{−}}), trifluoromethanesulfonic acid anion (CF₃SO₃_{^{−}})(TF), bis(trifluoromethanesulfonyl)imido anion (N(CF₃SO₂)₂_{^{−}}, (TFSI) and iodide ion (I⁻); and molten salts of an aliphatic quaternary ammonium cation with BF₄_{^{−}}, PF₆_{^{−}}, TF, TFSI and I⁻.

Examples to be used preferably as the imidazolium type cation may be 1-ethyl-3-methylimidazolium (EMI) ion, 1-butyl-3-methylimidazolium (BMI) ion, 1-hexyl-3-methylimidazolium (HMI) ion, 1-propyl-3-methylimidazolium (MPI) ion, 1,2-dimethyl-3-propylimidazolium (DMPI) ion, etc. Examples to be used preferably as aliphatic quaternary ammonium type cation may be tetraethylammonium (TEA) ion, triethylmethylammonium (TEMA) ion, trimethylpropylammonium (TMPA) ion, etc. Examples to be used preferably as other cation species may be methylpropylpipelidinium (MPPi) ion, butylmethylpipelidinium (BMPi) ion, methylpropylpyrrolidinium (MPPy) ion, butylmethylpyrrolidinium (BMPy) ion, etc.

Further, since having a wide potential window to redox even in the ionic liquid, TMPA-TFSI, MPPy-TFSI, EMI-TFSI and EMI-TF are preferable.

A furthermore preferable ionic liquid is those having a potential window, viscosity and/or ion conductivity in the following ranges.

The potential window of the ionic liquid is preferably in a range of −2.5 to 2.0 V vs. Ag/Ag⁺. If the potential in the lower potential side is higher than −2.5 V, alkali metals such as sodium and potassium and alkaline earth metals such as magnesium, calcium and strontium are difficult to be used as an active material. If the potential in the higher potential side is lower than 2.0 V, a material such as uranium and sulfur is difficult to be used as an active material. A more potential window of the ionic liquid is in a range of −2.0 to 1.5 V vs. Ag/Ag⁺. If the potential in the lower potential side is higher than −2.0 V, the potential becomes higher than hydrogen generation potential and the advantage of the ionic liquid to a water-based type solvent is sometimes lowered. If the potential in the higher potential side is lower than 1.5 V, the advantage of the ionic liquid to a water-based type solvent is sometimes lowered. If the potential window is in the range, a battery with higher electro motive force can be configured. Additionally, the potential window means a value obtained by measuring potential at which abrupt oxidation current or reduction current is detected when cyclic voltammetry is carried out.

The viscosity of the ionic liquid is preferably in a range of 1 to 500 mPa·s at 20° C. If the viscosity is lower than 1 mPa·s, the stability of the ionic liquid may be lowered in some cases. If viscosity is higher than 500 mPa·s, the load of a pump for circulating the ionic liquid may become too high in some cases. A more preferable viscosity is in a range of 10 to 150 mPa·s and if viscosity is in the range, penetration of the ionic liquid in the negative electrode can be carried out well. Additionally, the viscosity means a value obtained by measurement with AR 2000 manufactured by TA Instruments.

The ion conductivity of the ionic liquid is preferably in a range of 0.05 to 25 mS/cm at 25° C. If the ion conductivity is lower than 0.05 mS/cm, the electric resistance of the battery becomes too high and thus the energy efficiency of charge/discharge may be lowered in some cases. If the ion conductivity is higher than 25 mS/cm, current leakage becomes significant and therefore, the energy storability may be lowered in some cases. A furthermore preferable ion conductivity is in a range of 1 to 15 mS/cm and if it is in the range, charge/discharge reactions of the redox flow battery can be carried out well. Additionally, the ion conductivity means a value obtained by measuring alternate current impedance at 1000 Hz using 1280Z type electrochemical measurement system manufactured by SOLARTRON PUBLIC COMPANY LIMITED.

It is preferable to use a nonaqueous solvent in a range of 1 to 200 parts by weight to 100 parts by weight of solid negative electrode active material particles. Using the nonaqueous solvent within the range gives higher energy density and charge efficiency. The use amount of the nonaqueous solvent is more preferably in a range of 5 to 100 parts by weight.

(3) Supporting Electrolyte

A supporting electrolyte may be added to the negative electrode solution in order to improve the ion conductivity of the nonaqueous solvent and configure a redox flow battery using the nonaqueous solvent with high output performance.

Examples to be used as the supporting electrolyte may include lithium salts such as lithium perchlorate, lithium borofluoride (LiBF₄), lithium hexafluorophosphate (LIPF₆), lithium trifluoroacetate (LiCF₃COO), lithium trifluoromethanesulfonate (LiCF₃SO₃), bis(trifluoromethanesulfonyl)imide lithium (LiN(CF₃SO₂)₂), etc. Further, also usable is a salt of at least one kind of cations selected from sodium, potassium, rubidium, cesium and tetramethylammonium, and at least one kind of anions selected from borofluoride anion (BF₄_{^{−}}, hexafluorophosphate anion (PF₆_{^{−}}), trifluoromethanesulfonate anion (CF₃SO₃_{^{−}}(TF), bis(trifluoromethanesulfonyl)imido anion (N(CF₃SO₂)₂_{^{−}}(TFSI) and iodide ion (I⁻).

The addition amount of the supporting electrolyte is preferably in a range of 0.01 to 2 mol/L to the entire negative electrode solution. In order to configure a redox flow battery using an ionic liquid particularly having high output performance, it is more preferable in a range of 0.1 to 1 mol/L.

Particularly, in the case where a metal such as lithium, sodium or potassium is used as the solid negative electrode material particles, the supporting electrolyte is preferably a salt containing the metal ion. For example, in the case where lithium is used as the solid negative electrode active material particles, the supporting electrolyte is preferably a lithium salt such as lithium hexafluorophosphate (LiPF₆). Employment of a combination of the same metal types as described above makes it easy to cause the redox reaction of the solid negative electrode active material particles in the negative electrode cell and the metal ion contained in the supporting electrolyte also involves the reactions and therefore, the charge/discharge efficiency can be increased.

(4) Negative Electrode Current Collector

The negative electrode current collector has a function of collecting power by receiving electrons from solid negative electrode active material particles.

The negative electrode current collector is made of a foamed body, a sintered metal nonwoven fabric, an expanded material or a mesh-processed material and has a porous property. The negative electrode current collector is preferably installed adjacently to the negative electrode casing and the separator. Accordingly, almost all of the negative electrode solution can be passed through the insides of fine pores of the negative electrode current collector from the flow-in port of the negative electrode solution to the flow-out port of the negative electrode solution. Consequently, the collision probability of the negative electrode current collector and the solid negative electrode active material particles can be increased.

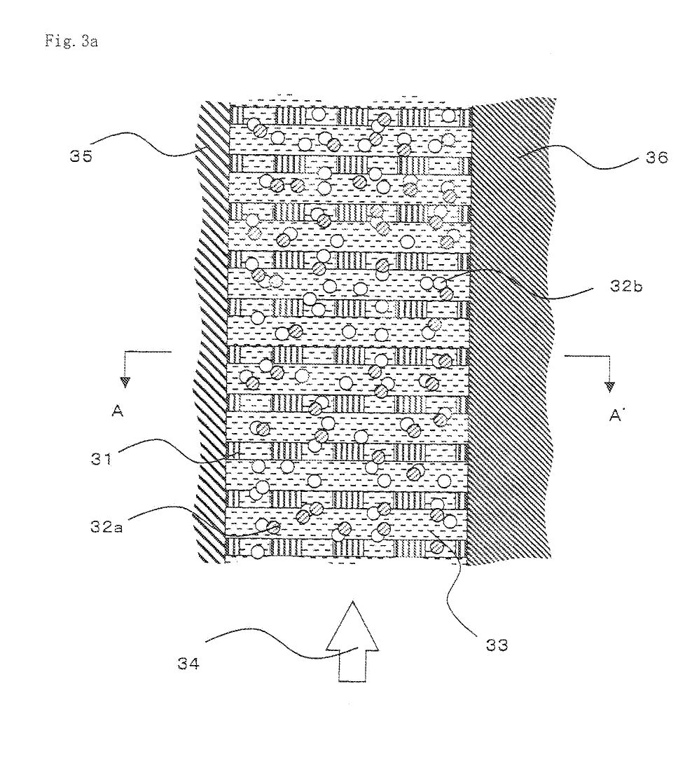

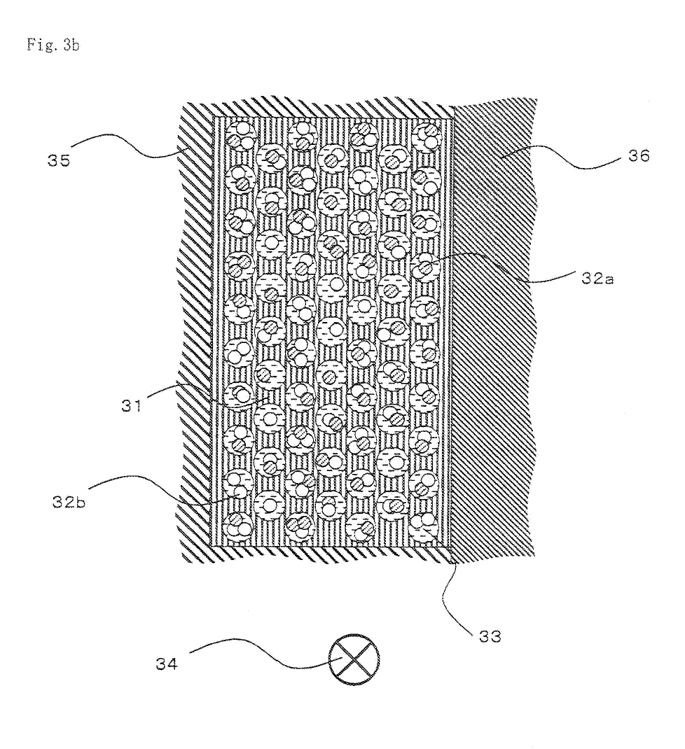

FIG. 3a is a schematic cross sectional view of one example of a negative electrode current collector and the drawing also shows the flow direction of the negative electrode solution together. FIG. 3b is a schematic cross sectional view in the A-A′ plane of FIG. 3a. In FIGS. 3a and 3b, the flow direction of the negative electrode solution is parallel to the direction from the flow-in port and the flow-out port of the negative electrode solution. In these drawings, the numeral reference 31 indicates a negative electrode current collector; 32a and 32b indicate solid negative electrode active material particles; 33 indicates a non-aqueous solvent; 34 indicates the flow direction of the negative electrode solution; 35 indicates a casing; and 36 indicates a separator. As shown in these drawings, in the negative electrode cell, the current collector 31 is positioned between the casing 35 and the separator 36. In the current collector 31, a plurality of pores exist and thus the current collector is porous. The negative electrode solution containing solid negative electrode active material particles 32a and 32b and the non-aqueous solvent 33 flows along the flow direction 34 of the negative electrode solution in the current collector 31.

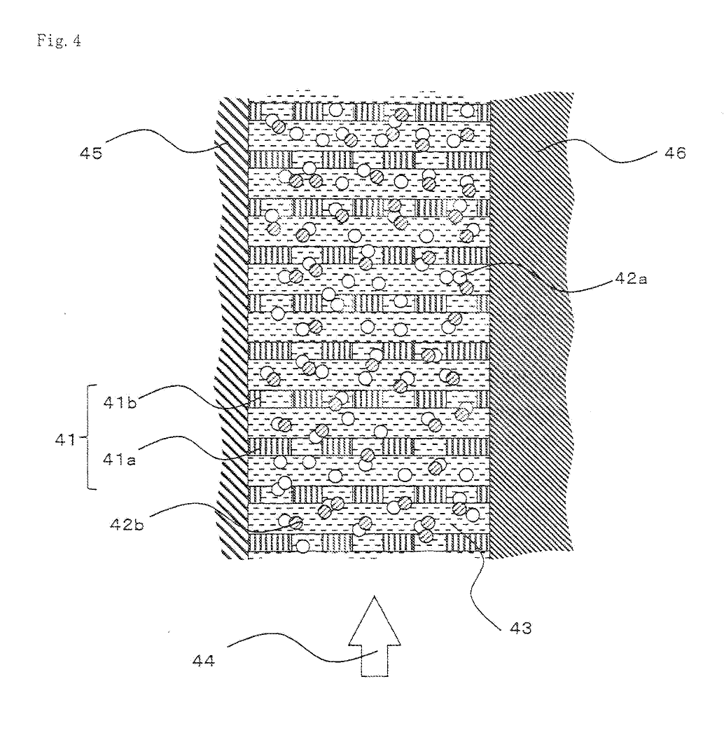

FIG. 4 is a schematic cross sectional view of another example of a negative electrode current collector and the drawing also shows the flow direction of the negative electrode solution together. In FIG. 4, the flow direction of the negative electrode solution meanders in the direction from the flow-in port and the flow-out port of the negative electrode solution. In these drawings, the numeral reference 41 indicates a negative electrode current collector; 42a and 42b indicate solid negative electrode active material particles; 43 indicates a non-aqueous solvent; 44 indicates the flow direction of the negative electrode solution; 45 indicates a casing; and 46 indicates a separator. The negative electrode current collector 41 includes a first negative electrode current collector 41a and a second negative electrode current collector 41b. As shown in FIG. 4, in the negative electrode cell, the current collector 41 is positioned between the casing 45 and the separator 46. In the current collector 41, a plurality of pores exist and thus the current collector is porous. The negative electrode solution containing solid negative electrode active material particles 42a and 42b and the non-aqueous solvent 43 flows along the flow direction 44 of the negative electrode solution in the current collector 41.

Herein, in FIG. 4, the aperture of the first negative electrode current collector 41a and the aperture of the second negative electrode current collector 41b are arranged while being periodically shifted from each other. As a result, the flow direction of the negative electrode solution meanders in the direction from the flow-in port and the flow-out port of the negative electrode solution.

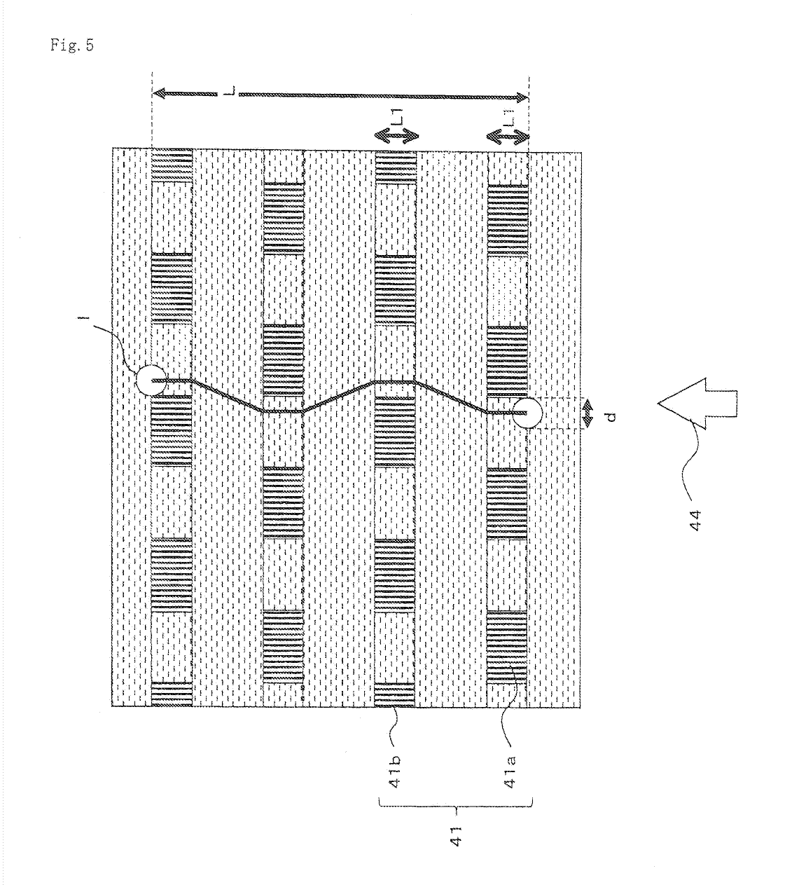

Next, the meandering of the negative electrode solution will be described with reference to FIG. 5. The length 1 of a solution sending channel for solid negative electrode active material particles in the negative electrode solution is preferable to satisfy the following relational expression; 1≧2nL1+(2n−1){(d²+(L−2nL1)/(2n−1))²}^{0.5}. In the expression, L denotes the length of the negative electrode current collector; L1 denotes the length (thickness) of the first negative electrode current collector and the second negative electrode current collector; d denotes the average particle diameter of the solid negative electrode active material particles; and n denotes the number of pairs of the first negative electrode current collector and the second negative electrode current collector. Herein, the example shown is the case that the first negative electrode current collector and the second negative electrode current collector have the same thickness.

The solid negative electrode active material particles flowing in the first negative electrode current collector in parallel to the flow direction of the negative electrode solution and the solid negative electrode active material particles flowing in the second negative electrode current collector in parallel can efficiently come into collision against the downstream second negative electrode current collector and against the downstream first negative electrode current, respectively, by satisfying the above-mentioned relational expression. As a result, giving and receiving of electrons between the solid negative electrode active material particles and the negative electrode current collectors can efficiently be carried out and the charge/discharge efficiency can be increased. Further, in the current collector, the flow of the negative electrode solution tends to be irregular in the pores of the current collector and sending pressure difference tends to be partially generated due to a turbulent current. As a result, clogging of the negative electrode current collector due to deposition of the solid negative electrode active material particles can be suppressed.

Examples of the negative electrode current collector may be metal materials, carbonaceous materials, conductive metal oxide materials, etc.

Those preferable as the metal materials are materials having electron conductivity and corrosion resistance in acidic atmosphere. Practically, noble metals such as Au, Pt and Pd; and Ti, Ta, W, Nb, Ni, Al, Cr, Ag, Cu, Zn, Su and Si can be used. Nitrides and carbides of these metal materials, stainless steel, and alloys such as Cu—Cr, Ni—Cr and Ti-Pt are also usable. The metal material is preferable to contain at least one element selected from a group consisting of Pt, Ti, Au, Ag, Cu, Ni and W from a viewpoint that other chemical auxiliary reactions are less. Since having a low specific resistance, these metal materials can suppress decrease of voltage even if electric current is taken out in a plane direction.

Those preferable as the carbonaceous materials are materials chemically stable and having conductivity. Examples are carbon powders and carbon fibers such as acetylene black, Balkan, ketjen black, furnace black, VGCF, carbon nanotubes, carbon nanohorns, fullerene, etc.

Examples of the conductive metal oxide materials may be tin oxide, indium tin oxide (ITO), antimony oxide-doped tin oxide, etc.

Further, in the case of using a metal material such as Cu, Ag and Zn poor in corrosion resistance under acidic atmosphere, the surface of the above-mentioned metal poor in the corrosion resistance may be coated with noble metals such as Au, Pt and Pd and metals having corrosion resistance, such as carbon, graphite, glassy carbon, conductive polymers, conductive nitrides, conductive carbides and conductive oxides.

Examples of the conductive polymers are polyacetylene, polythiophene, polyaniline, polypyrrole, poly(p-phenylene), poly(p-phenylene-vinylene), etc. Examples of the conductive nitrides are carbon nitride, silicon nitride, gallium nitride, indium nitride, germanium nitride, titanium nitride, zirconium nitride, thallium nitride, etc. Examples of the conductive carbons are tantalum carbide, silicon carbide, zirconium carbide, titanium carbide, molybdenum carbide, niobium carbide, iron carbide, nickel carbide, hafnium carbide, tungsten carbide, vanadium carbide, chromium carbide, etc. Examples of the conductive metal oxide materials are tin oxide, indium tin oxide (ITO), antimony oxide-doped tin oxide, etc.

### (B) Positive Electrode Solution

### (1) Solid Positive Electrode Active Material Particles

Examples of solid positive electrode active material particles are particles of lithium manganate, lithium nickelate, sulfur, tetra-valent or penta-valent vanadium oxide, etc. The particle diameter of the solid positive electrode active material particles is preferably 0.01 to 100 μm.

In the case where a slurry type electrode solution is used for both of the negative electrode cell and the positive electrode cell:

(i) in the case of using lithium ion as an ion species, a preferable combination is use of lithium metal or a tin type or silicon type lithium alloy for the solid negative electrode active material particles and use of lithium manganate, lithium nickelate or sulfur for the solid positive electrode active material particles; and

(ii) in the case of using hydrogen ion or hydroxide ion as an ion species, a preferable combination is use of an organic compound material such as quinone type ones (e.g. benzoquinone, naphthoquinone and anthraquinone) and thiol type ones (e.g. benzene thiol, butane-2,3-dithiol and hex-5-ene-3-thiol) or di-valent or tri-valent vanadium oxide for the solid negative electrode active material particles and use of tetra-valent or penta-valent vanadium oxide for the solid positive electrode active material particles.

(2) The same non-aqueous solvent of the negative electrode solution, supporting electrolyte and negative electrode current collector may be used for the non-aqueous solvent of the positive electrode solution, supporting electrolyte and positive electrode current collector.

(C) Slurry type negative electrode solution and positive electrode solution may be used for both of the negative electrode cell and the positive electrode cell and a slurry type electrode solution may be used for only one of them. In this case, for example, an electrode solution containing an electrode active material and a non-aqueous solvent and which is used for a non-aqueous rechargeable battery may be used for the other electrode cell.

In the electrode active material, lithium-containing oxides may be used as the positive electrode active material. Practically, examples may be lithium-containing metal oxides such as LiCoO₂, LiNiO₂, LiMn₂O₄, LiNi₁₋ₓMₓO₂ (M is a transition metal element), LiCoₓNi₁₋ₓO₂ (0<x<1) and in the case of using one of these oxides and a carbonaceous material as the negative electrode active material, the battery is provided with advantages; that is, sufficiently practically applicable operational voltage is obtained even if the voltage fluctuation (about 1 V vs Li/Li⁺) following the charge/discharge of the carbonaceous material itself occurs and also Li ion needed for charge/discharge reactions of the battery is contained already in form of, for example, LiCoO₂, LiNIO₂, etc. in the battery before assembly of the battery. Further, other examples as the positive electrode active material may be transition metal such as vanadium, uranium, iron and chromium; and sulfur.

Among them, since having high energy density per unit volume and suitable for miniaturizing the system, lithium manganate, lithium nickelate and sulfur are preferable to be used.

As a negative electrode active material, black lead type carbon materials can generally be used. The black lead type carbon materials may include, for example, natural graphite, artificial graphite in granular form (e.g. scaly, agglomerated, fibrous, whisker-like, spherical, crushed form), highly crystalline graphite represented by graphitized products such as meso-carbon micro-beads, meso-phase pitch powder and isotropic pitch powder, and hardly graphitizable carbon such as resin-fired carbon. Their mixtures may also be used. Further, tin oxide, silicon type negative electrode active materials, and alloy type negative electrode active materials with high capacity are also usable.

All of the solvent exemplified in the above-mentioned negative electrode solution are usable as the non-aqueous solvent. The nonaqueous solvent may be used in a range of 1 to 200 parts by weight to 100 parts by weight of electrode active material.

(Separator)

It is preferable to use those which prevent mixing of the negative electrode active material and the positive electrode active material and have a function of conducting ions but insulating electrons for the separator.

For example, a film of a porous body made of polypropylene, polyethylene, polytetrafluoroethylene (PTFE), polyimides, glass fibers, etc. which are chemically stable for the electrode solution and having insulating property may be used for the separator. In the film of a porous body, a non-aqueous solvent loses fluidity owing to the capillarity of the fine pores by penetrating the fine pores in the film with the non-aqueous solvent. As a result, the film of a porous body selectively allows only ions to pass. Further, not only the porous film of a porous body having intentional fine pores as described but also an ion exchange film, which is a porous material having ion conductivity itself, may be used as the separator.

Particularly, in the case where a slurry type electrode solution is used for circulating at both of the negative electrode cell and the positive electrode cell, significant pressure difference tends to be generated between the negative electrode cell side and the positive electrode cell side due to deposition of the solid electrode active material particles. In this case, it is preferable to use an ion exchange film for the separator. Since an ion exchange film conducts ions in molecules of polymers composing the ion exchange membrane, even if pressure difference is generated, a non-aqueous solvent in the fine pores is hardly fluidized in the ion exchange film than in the porous separator. As a result, considerable decrease of the battery performance due to chemical short-circuit can be suppressed.

All of films conventionally known in the field of the art can be used as the ion exchange film and generally, proton conductive films cation exchange films, hydroxide ion conductive films, anion exchange films, etc. can be used.

(1) Proton Conductive Film

A material for a proton conductive film is not particularly limited if it is a material having proton conductivity and an electrically insulating property. Examples may be polymer films, inorganic films and composite films.

Examples of the polymer films are films of Nafion (manufactured by Du Pont De Nemours & Co.), Aciplex (manufactured by Asahi Chemical Industry Co., Ltd.) and Flemion (manufactured by Asahi Glass Co., Ltd.), which are perfluorosulfonic acid type electrolytic films; and hydrocarbon type electrolytic films of such as polystyrenesulfonic acid, sulfonated polyether ether ketone, etc. Further, polymers composing the above-mentioned polymer films may be filled in the fine pores of a porous film having no proton conductivity.

Examples of the inorganic films are films of phosphate glass, cesium hydrogen sulfate, poly(tungstophosphoric acid), ammonium polyphosphate, etc.

Examples of the composite films are films obtained by compounding organic substances such as sulfonated polyimide type polymers and sulfonated polyether ether ketone type polymers with inorganic substances such as tungstic acid, tungstophosphoric acid and sulfated zirconia in molecular level.

Further, in the case the battery is used under high temperature environments (e.g. 100° C. or higher), examples may be films of sulfonated polyimides, 2-acrylamido-2-methylpropanesulfonic acid (AMPS), sulfonated polybenzimidazole, phosphonated polybenzimidazole, cesium hydrogen sulfate, ammonium polyphosphate, etc.

The ion exchange film is preferable to have proton conductivity of 10⁻⁵ S/cm or higher. Having proton conductivity of 10⁻⁵ S/cm or higher, the ion exchange film can suppress decrease of voltage due to ohmic loss in the film. A more preferable ion exchange film is a polymer electrolytic film of a perfluorsulfonic acid polymer or a hydrocarbon type polymer having proton conductivity of 10⁻³ S/cm or higher. Examples of such a film are films of Nafion (manufactured by Du Pont De Nemours & Co.), Aciplex (manufactured by Asahi Chemical Industry Co., Ltd.) and Flemion (manufactured by Asahi Glass Co., Ltd.).

In order to provide a water-repellent property, PTFE and PVDF may be added to the ion exchange film and contrarily, in order to provide hydrophilicity, silica particles and moisture-absorbing resins may be added.

(2) Cation Exchange Film

The cation exchange film may be of a solid polymer electrolyte which can transport cation such as lithium ion, sodium ion and potassium ion. Practically, examples may be fluoro type ion exchange films such as perfluorocarbonsulfonic acid film and perfluorocarboncarboxylic acid film; polybenzimidazole film impregnated with phosphoric acid, polystyrenesulfonic acid film, sulfonated styrene-vinylbenzene copolymer film, etc.

(3) Anion Exchange Film

In the case where the anion transportation ratio of the electrode solution is high, an anion exchange film may be used. A solid polymer electrolytic film in which anion can move can be used as the anion exchange film. Practical examples may be poly(o-phenylenediamine) films, fluoro type ion exchange films having ammonium-derived groups, vinylbenzene polymer films having ammonium-derived groups, films of aminated chloromethylstyrene-vinylbenzene copolymers, aromatic polymer films having a pyridine ring or a pyrrolidine ring, etc.

(4) Ew Value

The ion exchange film is preferable to have an Ew value in a range of 400 to 2000. Particularly, in the case of an ion exchange film made of Nafion, the Ew value is preferable in a range of 800 to 1200. If the Ew value is low, the resistance of the battery may become high in some cases and if the Ew value is high, the film strength may become low in some cases for a battery such as a redox flow battery using a fluid. The Ew value is more preferably in a range of 900 to 1100.

The Ew value is a value defined according to the following expression.

Ew=dry weight of ion exchange film per equivalent of functional group=(dry weight of ion exchange film)/(number of functional groups having ion exchangeability).

The dry weight of an ion exchange film is a value measured by weighing an ion exchange film after vacuum-drying the film at 60° C. for 72 hours. The number of functional groups having ion exchangeability is a value measured by a sodium chloride titration method. Practically, the number of functional groups can be measured by quantitatively measuring active functional groups by measuring pH value after sodium chloride is added to the ion exchange film.

(5) Formation Method of Ion Exchange Film

An ion exchange film can be formed by a conventionally known method. Examples may be methods for coating a current collector of a positive electrode or a negative electrode by an electrolytic polymerization method, a plasma polymerization method, a liquid-phase polymerization method, a solid-phase polymerization method, etc. These methods may be selected properly in accordance with the types of monomers for film production. Further, deposition (coating) may be carried out by directly immersing a current collector in a polymer solution composing the ion exchange film. Generally, the coating amount is preferably at least 1 mg/cm² or higher and more preferably 2 mg/cm² or higher. The upper limit of the coating amount is preferably 5 mg/cm².

(Tank)

An electrode solution is stored in a tank. Herein, in the case of using a slurry type positive electrode solution, a tank for storing the positive electrode solution is needed and in the case of using a slurry type negative electrode solution, a tank for storing the negative electrode solution is needed and in the case of using slurry type electrode solutions for the positive electrode cell and the negative electrode cell, respectively, tanks for storing the positive electrode solution and the negative electrode solution are needed. The shape of the tank is not particularly limited and may be determined property in accordance with the application or the use site of the battery. Further, the capacity of a tank may be determined properly in accordance with the desired capacity of the battery. Furthermore, a material for composing the tank is not particularly limited if it can keep the electrode solution.

(Pipe)

A pipe is so connected as to circulate the electrode solution between the tank and the electrode cell. The shape of the pipe is not particularly limited and may be determined property in accordance with the application or the use site of the battery. Furthermore, a material for composing the pipe is not particularly limited if it can keep the electrode solution.

### (Other Constituent Members)

(1) Pump

A pump is used for circulating the electrode solution between the electrode cell and the tank. As long as having the function, the configuration and type are not limited. For example, in the case where current amount at the time of charge/discharge is several A order, it is preferable to use a pump having a function of discharging the electrode solution at flow speed of 1 ml/min or higher. In the case where current amount at the time of charge/discharge is several tens A order, the flow speed of the electrode solution is increased to supply an electrode solution in a necessary amount; however if the flow speed is increased, the pressure in the pipe and the inside of the electrode cell is increased and a special pump for giving high jetting pressure has to be employed and therefore, the upper limit of the flow speed is preferably 100 L/min.

(2) Control Circuit

It is preferable that a control circuit for flow speed control of the slurry type electrode solution is installed in the pump to variably adjust the flow speed of the electrode solution.

For example, the control circuit outputs a first output level and a second output level described below to the pump. Practically, the flow speed of the electrode solution generated by the pump based on the second output level is set higher than the flow speed generated by the pump based on the first output level and the intermittent fluctuation from the first output level to the second output level can be carried out periodically. By carrying out the output control, while suppressing the power consumption of the pump, the electrode solution in the fine pores of the porous current collector can be transported at a high flow speed intermittently. As a result, the solid electrode active material particles deposited in the fine pores can efficiently be flow out. That is, since deposition of the solid electrode active material particles can be prevented and therefore, decrease of the surface area of the current collector can be suppressed and charge/discharge at high current density can be maintained.

Further, it is preferable that the flow of the electrode solution in the fine pores of the porous current collector is stratified current (laminar flow) in the first output level and turbulent current (turbulent flow) in the second output level. The voltage at the time of charge/discharge can be stabilized by making the current of the electrode solution be stratified current. On the other hand, the solid electrode active material particles deposited in the fine pores in the current collector can efficiently be removed by making the current of the electrode solution intermittently be turbulent current for a short time.

Particularly, in the case a metal material such as lithium, sodium; and potassium is used as the solid electrode active material particles, the flow of the electrode solution in the fine pores of the current collector is preferably made to be stratified current in the first output level and turbulent current in the second output level only for the charge time. Consequently, the surface area of the current collector is increased and the charge efficiency is improved due to a needle-like precipitate (dendrite precipitate) generated on the current collector surface under the stratified current. Further, dendrite precipitate with a prescribed size or larger is suppressed and clogging of the fine pores can be suppressed by breaking and removing the dendrite precipitate by the intermittent turbulent current.

Further, it is preferable that the first output level and the second output level are adjusted in a manner that the flow speed of the electrode solution in the second output level is three or more times as high as the flow speed of the electrode solution in the first output level. It is more preferable to carry out the adjustment in a manner of adjusting to be 5 to 20 times as high. Herein, the flow speed of the electrode solution in the first output level is preferably in a range of 1 ml/min to 100 L/min.

Further, it is preferable that the time of the first output level applied to the pump is 10 or less times as long as the time of the second output level applied. It is more preferable to carry out the adjustment in a manner of adjusting to be 3 to 5 times as long.

Further, it is preferable that the number of times of the second output level applied is 1 times/hour or more. It is more preferable to carry out the adjustment in a manner of adjusting to be 1 to 60 times/hour. The time of the second output level applied may be even or different. Furthermore, the interval of application may be even or different.

The present invention can provide a redox flow battery with energy density of, for example, 100 Wh/L or higher. The energy density is about 3 to 5 times as much as those of conventionally known batteries using the above-mentioned solution-type electrode solutions and it means that the redox flow battery of the present invention can efficiently store power.

### EXAMPLES

### Example 1

A redox flow battery shown in FIG. 1 was produced as follows.

At first, 100 ml of a mixed solvent of ethylene carbonate and dimethyl carbonate at a mixing ratio of 50:50 as a non-aqueous solvent, 5 g of a Li powder with an average particle diameter of 10 μm as solid negative electrode active material particles, and 10 g of lithium hexafluorophosphate as a supporting electrolyte were mixed in a chamber in inert Ar gas atmosphere. Next, the respective components in the mixture were dispersed by an ultrasonic probe to produce an aimed slurry type negative electrode solution.

On the other hand, 100 parts by weight of lithium cobaltate with an average particle diameter of 7 μm as a positive electrode active material, 5 parts by weight of acetylene black (Denka Black, manufactured by Denki Kagaku Kogyo K. K.) with an average particle diameter of 20 nm as a conductive auxiliary agent, and a PVdF solution (manufactured by Kureha Co., Ltd.) as a binder were adjusted and mixed by N-methyl-2-pyrrolidone (NMP). The PVdF solution was mixed in a manner that the amount of PVdF became 5 parts by weight. Next, after a proper amount of N-methylpyrrolidone was added to the mixture to adjust the viscosity to be 500 cps, the mixture was kneaded by a coiler to produce a positive electrode coating material to be a precursor of a positive electrode. Further next, the positive electrode coating material was applied in an amount of 10 mg/cm² to a 20 μm-thick aluminum foil as a positive electrode current collector. After the coating film was dried, the aluminum foil was pressed to form a positive electrode sheet. The obtained sheet was cut in a size of 30×30 mm to produce an aimed positive electrode.

Still further, a porous polyethylene film with a thickness of 50 μm (manufactured by Asahi Kasei Chemicals Co. Ltd.) was cut in a size of 50×50 mm to obtain a separator. The obtained separator was previously doped with the mixed solvent of ethylene carbonate and dimethyl carbonate at a mixing ratio of 50:50 as a non-aqueous solvent.

Still further, a nickel foamed metal with a thickness of 5 mm and an average fine pore diameter of 0.5 mm (manufactured by Mitsubishi Materials Corp.) was cut in a size of 30×30 mm to produce a negative electrode current collector.

Carbon plates with a thickness of 5 mm and a size of 50×50 mm were used for a negative electrode casing and a positive electrode casing. A recessed part with a depth of 500 μm and a size of 30×30 mm was formed in the center of one face of the carbon plate for the negative electrode casing by cutting. Further, 2 through holes from the face reverse to the face in which the recessed part was formed to the recessed part were formed to be a negative electrode solution flow-in port and a negative electrode solution flow-out port.

After the negative electrode current collector was assembled in the recessed part of the carbon plate for a negative electrode casing, a separator was laid over the carbon plate. Next, the positive electrode previously impregnated with the mixed solvent of ethylene carbonate and dimethyl carbonate at a mixing ratio of 50:50 was laminated. Thereafter, while the outer circumferential parts of the carbon plate for a negative electrode casing and the carbon plate for a positive electrode casing being fitted, the separator was sandwiched to produce a negative electrode cell and a positive electrode cell.

Next, a stainless steel tank for storing the negative electrode solution (a negative electrode tank) and the negative electrode cell were connected by a stainless pipe equipped with a liquid sending pump for circulating the slurry type negative electrode solution. The negative electrode tank was loaded with 100 mL of the negative electrode solution which was circulated at a flow speed of 5 ml/min.

Through the above-mentioned steps, a redox flow battery having energy density of 80 Wh/L was obtained.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 3.0 V. Even after 10 times of charge/discharge cycle, fluctuation of the liquid sending amount due to clogging of the negative electrode current collector was not particularly observed.

### Example 2

Production and evaluation of a redox flow battery with energy density of 72 Wh/L were carried out in the same manner as those of Example 1, except that an aimed slurry type negative electrode solution was produced by mixing 100 ml of a mixed solvent of ethylene carbonate and dimethyl carbonate, 5 g of graphite (manufactured by Nippon Carbon Co., Ltd.) with an average particle diameter of 10 μm as solid negative electrode active material particles, and 10 g of lithium hexafluorophosphate as a supporting electrolyte were mixed in a chamber in inert Ar gas atmosphere and dispersing the respective components of the mixture by an ultrasonic probe.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 2.8 V. Even after 10 times of charge/discharge cycle, fluctuation of the liquid sending amount due to clogging of the negative electrode current collector was not particularly observed.

### Example 3

Production and evaluation of a redox flow battery with energy density of 61 Wh/L were carried out in the same manner as those of Example 1, except that an aimed slurry type negative electrode solution was produced by mixing 100 ml of a mixed solvent of ethylene carbonate and dimethyl carbonate, 5 g of a lithium-tin alloy (Li:Sn=1:1 atom ratio) with an average particle diameter of 10 μm as solid negative electrode active material particles, and 10 g of lithium hexafluorophosphate as a supporting electrolyte were mixed in a chamber in inert Ar gas atmosphere and dispersing the respective components of the mixture by an ultrasonic probe.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 2.7 V. Even after 10 times of charge/discharge cycle, fluctuation of the liquid sending amount due to clogging of the negative electrode current collector was not particularly observed.

### Example 4

An ionic liquid EMI-TF was used as a non-aqueous solvent for a negative electrode cell and a positive electrode cell; vanadyl sulfate with an average particle diameter of 10 μm as solid type negative electrode active material particles was used; vanadyl chloride with an average particle diameter of 10 μm as solid type positive electrode active material particles was used; a slurry type negative electrode solution was used by mixing 10 g of vanadyl sulfate to 100 ml of EMI-TF; and a slurry type positive electrode solution was produced by mixing 10 g of vanadyl chloride to 100 ml of EMI-TF.

A positive electrode cell was produced in the same manner as that in the negative electrode cell side and a stainless steel positive electrode tank and the positive electrode cell were connected by a stainless pipe equipped with a liquid sending pump for circulating the slurry type positive electrode solution. The positive electrode tank was loaded with 100 mL of the slurry type positive electrode solution which was circulated at a flow speed of 5 ml/min.

A redox flow battery with energy density of 15 Wh/L was obtained in the same manner as that of Example 1, except that the above-mentioned steps were performed.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 1.0 V. Even after 10 times of charge/discharge cycle, fluctuation of the liquid sending amount due to clogging of the negative electrode current collector was not particularly observed.

### Example 5

As a negative electrode active material, 100 parts by weight of a graphite powder with an average particle diameter of 1 μm; as a conductive auxiliary agent, 5 parts by weight of acetylene black (Denka Black, manufactured by Denki Kagaku Kogyo K. K.) with an average particle diameter of 20 nm; and as a binder, a PVdF solution (manufactured by Kureha Co., Ltd.) were adjusted and mixed by N-methyl-2-pyrrolidone (NMP). The PVdF solution was mixed in a manner that the amount of PVdF became 5 parts by weight. Next, after a proper amount of N-methylpyrrolidone was added to the mixture to adjust the viscosity to be 500 cps, the mixture was kneaded by a coiler to produce a negative electrode coating material to be a precursor of a negative electrode. Still next, the negative electrode coating material was applied in an amount of 10 mg/cm² to a 20 μm-thick aluminum foil as a negative electrode current collector.

Next, 100 ml of a mixed solvent of ethylene carbonate and dimethyl carbonate at a mixing ratio of 50:50 as a non-aqueous solvent, 10 g of a Li cobaltate powder with an average particle diameter of 7 μm as solid positive electrode active material particles, and 10 g of lithium hexafluorophosphate as a supporting electrolyte were mixed in a chamber in inert Ar gas atmosphere. Next, the respective components in the mixture were dispersed by an ultrasonic probe to produce an aimed slurry type positive electrode solution.

Production and evaluation of a redox flow battery with energy density of 40 Wh/L were carried out in the same manner as those of Example 1, except that the above-mentioned negative electrode and positive electrode solution were produced.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 2.5 V. Even after 10 times of charge/discharge cycle, fluctuation of the liquid sending amount due to clogging of the negative electrode current collector was not particularly observed.

### Example 6

As a non-aqueous solvent, 100 ml of a mixed solvent of ethylene carbonate and dimethyl carbonate at a mixing ratio of 50:50; as solid negative electrode active material particles, 1 g of a Li powder with an average particle diameter of 10 μm; and as a supporting electrolyte, 10 g of lithium hexafluorophosphate were mixed in a chamber in inert Ar gas atmosphere. Next, the respective components in the mixture were dispersed by an ultrasonic probe to produce an aimed slurry type negative electrode solution.

Further, as a positive electrode active material, 100 parts by weight of a TiS₂ powder with an average particle diameter of 7 μm; as a conductive auxiliary agent, 10 parts by weight of acetylene black (Denka Black, manufactured by Denki Kagaku Kogyo K. K.) with an average particle diameter of 20 nm; and as a binder, a PVdF solution (manufactured by Kureha Co., Ltd.) were adjusted and mixed by N-methyl-2-pyrrolidone (NMP). The PVdF solution was mixed in a manner that the amount of PVdF became 5 parts by weight. Next, after a proper amount of N-methylpyrrolidone was added to the mixture to adjust the viscosity to be 500 cps, the mixture was kneaded by a coiler to produce a positive electrode coating material to be a precursor of a positive electrode. Further next, the positive electrode coating material was applied in an amount of 1 g/cm² to a 20 μm-thick aluminum foil as a positive electrode current collector. After the coating film was dried, the aluminum foil was pressed to form a positive electrode sheet. The obtained sheet was cut in a size of 30×30 mm to produce an aimed positive electrode.

Still further, a porous polyethylene film with a thickness of 50 μm (manufactured by Asahi Kasei Chemicals Co. Ltd.) was cut in a size of 50×50 mm to obtain a separator. The obtained separator was previously doped with the mixed solvent of ethylene carbonate and dimethyl carbonate at a mixing ratio of 50:50 as a non-aqueous solvent.

Still further, a nickel foamed metal with a thickness 5 mm and an average fine pore diameter of 0.5 mm (manufactured by Mitsubishi Materials Corp.) was cut in a size of 30×30 mm to produce a negative electrode current collector.

Carbon plates with a thickness of 7 mm and a size of 50×50 mm were used for a negative electrode casing and a positive electrode casing. A recessed part with a depth of 5 mm and a size of 30×30 mm was formed in the center of one face of the carbon plate for the negative electrode casing by cutting. Further, 2 through holes from the face reverse to the face in which the recessed part was formed to the recessed part were formed to be a negative electrode solution flow-in port and a negative electrode solution flow-out port.

After the negative electrode current collector was assembled in the recessed part of the carbon plate for a negative electrode casing, a separator was laid over the carbon plate. Next, the positive electrode previously impregnated with the mixed solvent of ethylene carbonate and dimethyl carbonate at a mixing ratio of 50:50 was laminated. Thereafter, while the outer circumferential parts of the carbon plate for a negative electrode casing and the carbon plate for a positive electrode casing being fitted, the separator was sandwiched to produce a negative electrode cell and a positive electrode cell.

Next, a stainless steel negative electrode tank and the negative electrode cell were connected by a stainless pipe equipped with a liquid sending pump for circulating the slurry type negative electrode solution. The negative electrode tank was loaded with 100 mL of the negative electrode solution which was circulated at a flow speed of 5 ml/min.

Through the above-mentioned steps, a redox flow battery having energy density of 80 Wh/L was obtained.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 3.1 V. Even after 10 times of charge/discharge cycle, fluctuation of the liquid sending amount due to clogging of the negative electrode current collector was not particularly observed. Moreover, the charge/discharge efficiency at the 10th charge/discharge cycle was in a range of 75 to 77%.

### Comparative Example 1

A 4 mm-thick nickel plate (manufactured by Nilco Corporation) as a negative electrode current collector was cut in a size of 30×30 mm and a nickel wire with a diameter of 0.5 mm (manufactured by Nilco Corporation) was welded to the negative electrode current collector by a spot welting device to use it as a lead wire. Further, at the time of assembling the negative electrode current collector in the recessed part for a carbon plate for the negative electrode casing, a PTFE tube with a diameter of 1.0 mm and a length of 2 mm was used as a buffer material between the negative electrode casing and the negative electrode current collector to conform the heights of the negative electrode current collector and the negative electrode casing with each other and a separator was laid over the carbon plate for the negative electrode casing. Production and evaluation of a redox flow battery with energy density of 80 Wh/L were carried out in the same manner as those of Example 1, except as described above.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 3.1 V. Even after 10 times of charge/discharge cycle, fluctuation of the liquid sending amount due to clogging of the negative electrode current collector was not particularly observed. Moreover, the charge/discharge efficiency of 10 times was in a range of 35 to 41%.

### Example 7

A redox flow battery with a configuration shown in FIG. 6 was produced as follows.

Production and evaluation of a redox flow battery with energy density of 80 Wh/L were carried out in the same manner as that of Comparative Example 1, except that as a negative electrode current collector, a 4 mm-thick nickel foamed metal (manufactured by Mitsubishi Materials Corp.) was cut in a size of 30×30 mm and a nickel wire with a diameter of 0.5 mm (manufactured by Nilco Corporation) was welded to the negative electrode current collector by a spot welting device to use it as a lead wire.

Using a charge/discharge apparatus, the obtained redox flow battery was charged at a constant current of 0.1 A for 12 hours. Thereafter, when discharge was carried out at a constant current of 0.1 A for 10 hours, the open circuit voltage was 3.0 V. Even after 10 times of charge/discharge cycle, fluctuation of the liquid sending amount due to clogging of the negative electrode current collector was not particularly observed. Moreover, the charge/discharge efficiency of 10 times was in a range of 56 to 62%.

### DESCRIPTION OF THE REFERENCE NUMERALS

A: redox flow battery
B: buffer material
1: negative electrode cell
2, 36, 46: separator
3, 14: current collector
4, 35, 45: casing
5: tank
6, 21: negative electrode solution
7: pipe
8a: flow-in port of the negative electrode solution to the negative electrode cell
8b: flow-out port of the negative electrode solution from the negative electrode cell
9a: flow-in port of the negative electrode solution to the tank
9b: flow-out port of the negative electrode solution from the tank
10: positive electrode cell
12: positive electrode active material
13, 23, 33, 43: non-aqueous solvent
15: pump.
22a, 22b, 32a, 32b, 42a, 42b: solid negative electrode active material particle
31, 41: negative electrode current collector
34, 44: flow direction of the negative electrode solution
41a: first negative electrode current collector
41b: second negative electrode current collector

1. A redox flow battery comprising an electrode cell including a negative electrode cell, a positive electrode cell and a separator for separating them, in which at least one of the negative electrode cell and the positive electrode cell includes a slurry type electrode solution, a porous current collector and a casing; a tank for storing the slurry type electrode solution; and a pipe for circulating the slurry type electrode solution between the tank and the electrode cell,
wherein the slurry type electrode solution is the negative electrode solution in the negative electrode cell side and contains solid type negative electrode active material particles of metal particles and a non-aqueous solvent.

2. The redox flow battery according to claim 1, wherein the slurry type electrode solution is the negative electrode solution in the negative electrode cell side and contains solid type negative electrode active material particles of lithium particles.

3. The redox flow battery according to claim 1, wherein the slurry type electrode solution contains a non-aqueous type solvent of an ionic liquid.

4. The redox flow battery according to claim 1, wherein the slurry type electrode solution is the negative electrode solution in the negative electrode cell side, and the positive electrode cell contains a positive active material, a non-aqueous electrode solution and a current collector.

5. The redox flow battery according to claim 1, wherein the slurry type electrode solution contains the solid negative electrode active material particles or the solid positive electrode active material particles having the particle diameter of 0.01 to 100 μm.

6. The redox flow battery according to claim 1, the positive electrode cell has a slurry type positive electrode solution comprising a positive electrode active material particles selected from lithium manganate, lithium nickelate, sulfur, and tetra-valent or penta-valent vanadium oxide, and a non-aqueous solvent selected from a cyclic carbonate, a chain carbonate and an ionic liquid.

7. A redox flow battery comprising an electrode cell including a negative electrode cell, a positive electrode cell and a separator for separating them, in which at least one of the negative electrode cell and the positive electrode cell includes a slurry type electrode solution, a porous current collector, a casing and a control circuit for controlling the flow speed of the slurry type electrode solution,
wherein the control circuit is a circuit for controlling as intermittent and periodical fluctuating between a first output level for generating at least a first flow speed and a second output level for generating a second flow speed higher than the first flow speed.

8. The redox flow battery according to claim 7, wherein the first flow speed is in a range of 1 ml/min to 100 L/min.

9. The redox flow battery according to claim 7, wherein the second flow speed is 5 to 20 times of the first flow speed.

10. The redox flow battery according to claim 7 further comprising a pump for circulating the slurry type electrode solution between the electrode cell and the tank,
wherein the time of the first output level applied to the pump is 3 to 5 times as long as the time of the second output level applied.

11. The redox flow battery according to claim 7, wherein the second output level is applied to the pump at 60 times/hour.
